(19) United States
(12) Patent Application Publication
(10) Pub. No.: US 2012/0059758 A1
(43) Pub. Date: Mar. 8, 2012

(54) Protecting Express Enrollment Using a Challenge

(76) Inventor: Mark Carlson, Half Moon Bay, CA (US)

(21) Appl. No.: 13/223,176

(22) Filed: Aug. 31, 2011

Related U.S. Application Data
(60) Provisional application No. 61/379,990, filed on Sep. 3, 2010.

(51) Int. Cl. G06Q 40/02

(52) U.S. Cl. 705/39

(57) ABSTRACT

Embodiments of the invention relate to security features to prevent one from trying to enter multiple different payment card number combinations into a payment request form for an online transaction in an effort to probe for the accurate payment information.

### CROSS-REFERENCES TO RELATED APPLICATIONS

This application is a non-provisional of and claims benefit of the filing date of U.S. provisional patent application No. 61/379,990, filed on Sep. 3, 2010, which is herein incorporated by reference in its entirety for all purposes.

### BACKGROUND

Online purchase transactions are increasingly common, with benefits to both consumers, merchants, and issuers providing financial transactions of products and/or services. Consumers may prefer to conduct purchases online over the Internet because the financial transaction process may be more convenient and faster than going to a store and making the purchase in person. Making online purchases can save a lot of time for consumers, such as eliminating transportation time to the store, finding the product, and waiting in line. Additionally, online merchant sites are effectively open 24 hours a day, 7 days a week, and therefore consumers are not limited to making purchases during store hours. Online transactions are particularly profitable for issuers since cash purchases cannot be made over the Internet, therefore a payment card issued by an issuer must be used. However because of the relative anonymity associated with conducting transactions online over the Internet, online transactions may not be as secure as transactions made in person.

At a POS (point of service) terminal in a store when a credit card purchase is made, a person may sign a merchant copy of a receipt for the purchase. A store clerk can visually check that the signature on the merchant copy of the receipt matches the signature on the credit card, verifying the identity of the person making the purchase is authorized as the intended consumer. As another identification check, the store clerk may ask the person for his or her ID (e.g., driver's license) to compare it with the credit card used for purchase, and can visually check the person's identification and name with the consumer's payment information. Over the Internet, it is not possible to visually check the person wishing to make the purchase and confirm that he or she is indeed the consumer on the credit card. Therefore other security measures must be taken to confirm the identity of the person wishing to make the purchase and ensure that online purchase transactions are authorized by the consumer before the payment information is verified to clear the purchase.

Since there is less security in online transactions and no visual check of identification, it is easier for unauthorized purchases to occur with stolen payment information, or through malicious probing of credit card numbers combinations. Therefore improved payment systems and methods over the Internet are needed to properly identify, authorize, and verify payment information. Improved security will benefit and protect the consumer and also establish trust with the online merchant, and the issuer.

Other transactions that may be conducted over the Internet, such as registration to participate in programs or entry into a sweepstakes or contest, may also request payment information to verify the identity of the person. Administrators of such programs and contests may wish to limit the numbers of registrants or contest entries by a single person, even if that person is legitimate and not a victim of identity theft. A person may try to register multiple times with a program, or other service using multiple email addresses to gain one-time sign up benefits or promotions. A person may also enter multiple times for a sweepstakes or contest using multiple email addresses to increase his or her chances of winning. Organizers of such programs and contests may want to limit the number of repetitive entries and separate unique entries of unique people from repeated entries of the same person.

Embodiments of the invention address these and other problems.

### BRIEF SUMMARY

Aspects of embodiments of the present invention relate in general to improved consumer payment systems, apparatuses, and methods.

One embodiment of the invention is directed to a server computer apparatus comprising a processor and a computer-readable storage medium, wherein the computer-readable storage medium comprises code executable by the processor for implementing a method. The method comprises a payment processing network providing an online request form to a consumer and receiving account information including a device identifier from the online request form during an online purchase transaction. The payment processing network may then restrict access to the online request form, provide an input region, generate a confirmation code, and transmit the confirmation code to the device identifier. When the payment processing network receives the confirmation code via the input region, the payment processing network may allow access to the online request form if the confirmation code entered via the input region matches the generated confirmation code.

Another embodiment of the invention is directed to a method comprising providing an online request form to a consumer and receiving account information including a device identifier from the online request form during an online purchase transaction. The method further comprises restricting access to the online request form, providing an input region, generating a confirmation code, and transmitting the confirmation code to the device identifier provided from the online request form. Upon receiving the confirmation code via the input region, access to the online request form may be allowed if the confirmation code entered via the input region matches the generated confirmation code.

Another embodiment of the invention is directed to a client computer apparatus comprising a processor and a computer-readable storage medium, wherein the computer-readable storage medium comprises code executable by the process for implementing a method. The method comprises displaying an online request form to a consumer during an online purchase transaction, receiving account information, including a device identifier in the online request form, wherein the online request form is thereafter blocked. The method further comprises displaying an input region, receiving entry of a confirmation code in the input region, the confirmation code received by the device, and allowing the consumer to access the online request form.

Another embodiment of the invention is directed to a method comprising displaying an online request form to a consumer during an online purchase transaction, receiving account information, including a device identifier in the online request form, wherein the online request form is thereafter blocked. The method further comprises displaying an input region, receiving entry of a confirmation code in the input region, wherein the confirmation code is received by the device. The method further comprises allowing the consumer to access the online request form.

Another embodiment of the invention is directed to a method comprising blocking a payment request form until a confirmation code is provided, wherein the code was sent to an approved device; verifying payment information only when the confirmation code has been provided; limiting the number of attempts to provide the correct payment information associated with the device identifier; and sending a payment authorization request message to an issuer.

Embodiments of the invention are directed to a method and system for thwarting probing of card verification services in situations where valid card information needs to be collected on the World Wide Web, and no credentials or verification is practical.

Embodiments of the invention are directed to a method and system of restricting participation by introducing an additional verification step and imposing limitations in the enrollment process. Exemplary limitations include limiting of one address per phone number, and the number of payment cards enrolled.

Although payment transactions and other transactions described below may be conducted with a merchant, embodiments of the invention are not limited to transactions with merchants. Online transactions may be conducted between a consumer and one or more entities, such as service providers, sponsors, program administrators, contest administrators, or charities (e.g., to make a donation). Other transactions may include registration to any online account, participation in a program, entry into a sweepstakes, or other transaction with a process intended to limit enrollment to unique users.

These and other embodiments of the invention are described in further detail below.

### BRIEF DESCRIPTION OF THE DRAWINGS

FIG. 1 illustrates an exemplary system according to an embodiment of the invention.

FIG. 2 illustrates a block diagram of an exemplary payment processing network according to an embodiment of the invention.

FIG. 3 shows a flowchart of a method of conducting a transaction according to an embodiment of the invention.

FIG. 4 shows an exemplary screen of a form for requesting payment information.

FIG. 5 shows a screen with window for entering a code. The payment request form in FIG. 4 is blocked out.

FIG. 6 shows an exemplary computer apparatus, in which various embodiments may be implemented.

### DETAILED DESCRIPTION

Embodiments of the invention are directed to improved consumer payment systems, apparatuses, and methods.

In a typical online purchasing transaction, a consumer may need to provide payment information on a merchant's website to complete the transaction, or to register payment information with the merchant for future transactions. Payment information may include both account information, including the name of the person the transaction will be billed to, the billing address, the payment card number that will be billed, and contact information, such as email address, and device identifier (e.g., mobile device number).

The intent of gathering this payment information is to verify the identity of the consumer and ensure that the purchase will be authorized by the consumer. The merchant may work with an acquirer, a payment processing network, and the issuer associated with the payment account for the consumer. In certain embodiments, the payment processing network can use this data and retrieve the intended consumer's data for verification. Once the payment information has been verified, the payment can be authorized.

However, it may be desired to increase the security of the above described process. A consumer's payment card number can be acquired maliciously to make unauthorized online purchases. For example, it may be possible with most typical payment request online forms for people to maliciously probe, guess, and try different payment card numbers or other payment information in an attempt to make an unauthorized purchase. For example, a consumer's primary account number (PAN), credit verification value (CVV2), billing ZIP (zone improvement plan) code, and other information may be randomly created and confirmed, by constantly trying out combinations.

Embodiments of the invention address the problem of unauthorized online purchases through unlimited tries at guessing PAN/CVV2/ZIP numbers, and other payment information combinations, as well as other problems.

By collecting all payment and contact information, and then performing the certain verification steps, malicious probing can be deterred by providing an out of band step (e.g., a challenge to a mobile device) that slows down the transaction process.

In certain embodiments, a consumer would provide a working device identifier (e.g., mobile device number) and would need to prove it is in their possession before the consumer's payment card information is verified. Once a device identifier has been verified, it provides the payment processing network (e.g., VisaNet) with another piece of data to track the transaction. Thus, for example, probing can be limited to the number of mobile devices a prober has physical access to, and the certain number of “bad” attempts allowed per device before the device is locked out.

Prior to discussing the specific embodiments of the invention, a further description of some terms can be provided for a better understanding of embodiments of the invention.

A “merchant” may have a merchant website that can interact with a portable consumer device to conduct transactions with a consumer wishing to purchase products or services from the merchant website. The merchant website according to embodiments of the invention can be in any suitable form and can be accessed via the internet, telecommunications network, or any other suitable communications networks, using a client computer, mobile device, or any other suitable electronic device capable of connecting to a communications network.

The merchant website may be hosted on a server computer in communication with an “access device”. Examples of access devices include point of sale (POS) devices, cellular phones, PDAs, personal computers (PCs), tablet PCs, handheld specialized readers, set-top boxes, electronic cash registers (ECRs), automated teller machines (ATMs), virtual cash registers (VCRs), kiosks, security systems, access systems, and the like.

The “portable consumer device” may be in any suitable form. For example, suitable portable consumer devices can be hand-held and compact so that they can fit into a consumer's wallet and/or pocket (e.g., pocket-sized). They may include smart cards, credit or debit cards (with a magnetic stripe), keychain devices (such as the Speedpass™ commercially available from Exxon-Mobil Corp.), etc. Other examples of portable consumer devices include cellular phones, personal digital assistants (PDAs), pagers, payment cards, security cards, access cards, smart media, transponders, and the like. The portable consumer devices can also be debit devices (e.g., a debit card), credit devices (e.g., a credit card), or stored value devices (e.g., a stored value card).

An “issuer” may be any business entity (e.g., a bank). Typically, an issuer is a financial institution, such as a bank. The issuer issues portable consumer devices to the consumer that may be used to conduct a transaction, such as a credit or debit card to the consumer.

An “acquirer” is typically a business entity, e.g., a commercial bank that has a business relationship with a particular merchant. Some entities such as American Express perform both issuer and acquirer functions. Embodiments of the invention encompass such single entity issuer-acquirers.

A “payment processing network” may include data processing subsystems, networks, and operations used to support and deliver authorization services, exception file services, and clearing and settlement services. An exemplary payment processing system may include VisaNet™. Payment processing systems such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

A “server computer” can be a powerful computer or a cluster of computers. For example, the server computer can be a large mainframe, a minicomputer cluster, or a group of servers functioning as a unit. In one example, the server computer may be a database server coupled to a Web server and may host a merchant website.

An “authorization request message” can include a request for authorization to conduct an electronic payment transaction. It may further include an issuer account identifier. The issuer account identifier may be a payment card account identifier associated with a payment card. The authorization request message may request that an issuer of the payment card authorize a transaction. An authorization request message according to an embodiment of the invention may comply with ISO 8583, which is a standard for systems that exchange electronic transactions made by cardholders using payment cards.

An “authorization response message” can be a message that includes an authorization code, and may typically be produced by an issuer. The authorization response message can provide an indication of whether or not a transaction is authorized.

### System Overview

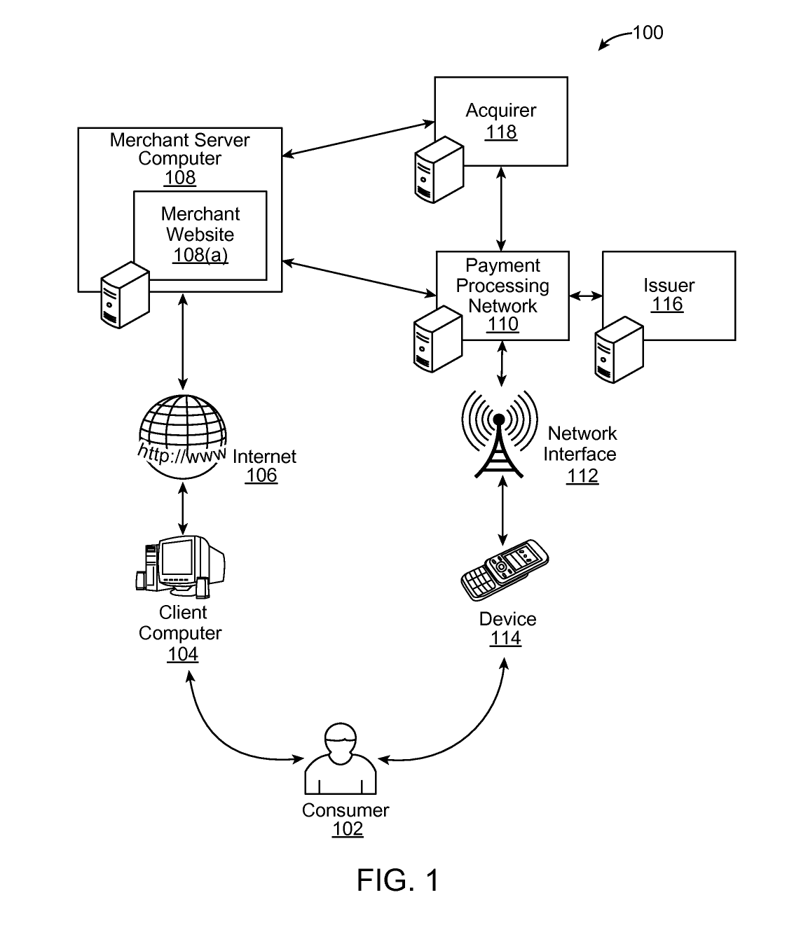

FIG. 1 shows a block diagram of a system 100 in accordance with an embodiment of the invention. A consumer 102 may use a client computer 104 to have access to a communication medium such as the Internet 106. The client computer 104 may be capable of displaying online forms, windows, pages, sites, and other items through the Internet 106. The consumer 102 may communicate with a merchant operating a merchant server computer 108, which can operate a merchant website 108(a). The merchant may be an individual or an organization such as a business that is capable of providing goods and services. The merchant server computer 108 may comprise a processor and a computer readable medium. The computer readable medium may comprise code or instructions for performing purchase functions. merchant server computer 108

Both the merchant server computer 108 and merchant website 108(a) may have access to the Internet 106, or other communication medium, through which the consumer 102 may have access to using a client computer 104. The Internet 106 allows the consumer 102 to access, browse, and make transactions on the merchant website 108(a).

In a purchase transaction, the consumer 102 may provide payment information, which includes account information and contact information, through the Internet 106 to the merchant website 108(a). Account information may include a primary account number (PAN), expiry date, credit verification value (CVV2), security code, etc. and the consumer's name and billing address, and also shipping information. The consumer 102 may also be asked to provide contact information for a consumer credential (e.g., alias) that is defined by the consumer and can be used for future transactions. An alias can be an email address, mobile phone number, nickname, username, or other alias chosen by the consumer and used by the merchant or payment processing network 110 to contact and identify the consumer 102. The merchant server computer 108 processes the payment information and sends it to a payment processing network 110. After sending the payment information to the payment processing network 110, the merchant server computer 108 itself may not store any of the information provided by the consumer 102.

The payment processing network 110 may include data processing subsystems, networks, and operations used to support and deliver authorization services, exception file services, and clearing and settlement services. A payment processing network 110 may be able to process payment card transactions, debit card transactions, and other types of commercial transactions. A payment processing network 110 may also processes authorization requests and a Base II system which performs clearing and settlement services. In an embodiment of the invention, the payment processing network 110 may verify the contact information provided by the consumer 102 to create an out of band process step, such as a challenge to a mobile device, to further verify the online transaction.

The payment processing network 110 may use any suitable wired or wireless network, or other suitable communication medium, including the Internet 106, and/or other network interface 112. The payment processing network 110 may have a server computer and a database associated with the server computer. The server computer may comprise a processor and a computer readable medium. The computer readable medium may comprise code or instructions for performing the various functions of the payment processing network 110.

The payment processing network 110 or merchant server computer 108 may be configured to block the consumer 102 from further editing the payment information, and send a confirmation code through a telecommunications network or other network interface 112 to the device 114 (e.g., mobile device). The consumer 102 may be requested to enter the confirmation code received on the device 114 into the client computer 104. If the consumer 102 can successfully enter the confirmation code sent to the device 114, then the payment processing network 110 may initiate verification of the account information.

According to embodiments of the invention, the payment processing network 110 may initiate verification of the account information after the confirmation code received via the input region matches the confirmation code generated. Initiating verification of the account information may include the payment processing network 110 verifying the account information internally, or transmitting the account information to another entity to verify the account information.

In some embodiments when the consumer 102 wishes to enroll the device identifier with the merchant, after the account information is verified, including approving the device identifier provided in the online request form, the payment processing network 110 may enroll the approved device identifier with the verified account information of the consumer 102 with the merchant. Therefore in the future, when the consumer 102 wishes to conduct a purchase transaction with the merchant via the merchant website 108(a), the merchant server computer 108 and the payment processing network 110 may immediately recognize the approved device identifier, expediting verification and authorization of the purchase transaction.

In other embodiments when the consumer 102 wishes to conduct a payment transaction with the merchant, after the account information is verified, the payment processing network 110 may generate an authorization request message or may inform the merchant server computer 108 to generate the authorization request message. It may be sent to an issuer 116 in communication with an acquirer 118 via the payment processing network 110. The issuer 116 may approve or not approve of the transaction and may send an authorization response message indicating whether or not the transaction is approved.

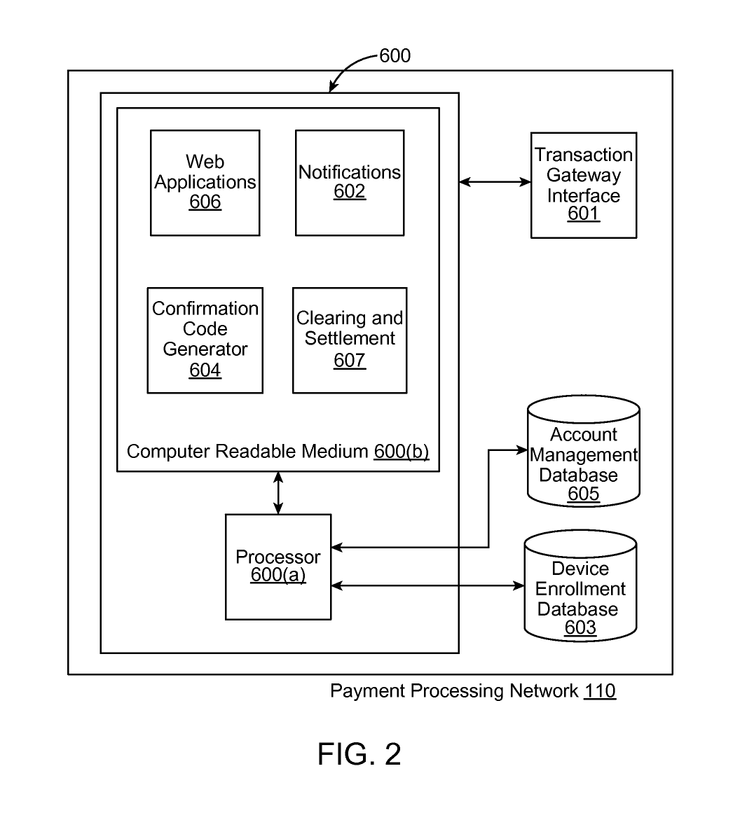

Further details regarding aspects of the payment processing network can be found in FIG. 2. FIG. 2 illustrates a payment processing network 110 according to embodiments of the invention. The payment processing network 110 may include data processing subsystems, networks, and operations used to support and deliver authorization services, exception file services, and clearing and settlement services.

The payment processing network 110 may be operated on a server computer 600 comprising a processor 600(a) and a computer readable medium 600(b) comprising code capable of being executed by the processor 600(a). The computer readable medium 600(b) may have a web application module 606 to provide Internet capabilities, such as providing the online payment information request form through the merchant website to the consumer, restricting access to the online payment information request form, providing an input region on the confirmation code request window, and re-allowing access to the online payment information request form. The web application module 606 may also provide applications for mobile devices with Internet capabilities. The computer readable medium 600(b) of the payment processing network may also comprise a confirmation code generator module 604 to generate the confirmation code to be sent to the consumer when the payment information has been received. The confirmation code generator module 604 may also match the confirmation code received via the input region of the confirmation code request window with the confirmation code generated and sent to the device identifier. When the confirmation code received via the input region matches and is accepted, the device identifier is approved. The payment processing network 110 may have a transaction gateway interface 601, to receive and transmit payment information provided through the online payment information request form associated with the transaction, including transmitting the confirmation code to the device identifier retrieved from the payment information received, and receiving the confirmation code entered into the input region of the confirmation code request window provided by the web application module 606.

The payment information, including account information (e.g., PAN, CVV2, billing information) and contact information (e.g., alias, device identifier), may then be stored and managed in an account management database 605 and a device enrollment database 603, respectively. These databases may be used by the payment processing network 110 to enroll approved device identifiers with their associated accounts and to verify payment information, including the device identifier. There may also be a clearing and settlement module 607 for processing authorization request and response messages between the issuer and acquirer to clear and settle the purchase transaction. The payment processing network 110, through the clearing and settlement module 607, may initiate verification of the purchase transaction when the confirmation code has been accepted. Further, there may be a notification module 602 to provide notifications and alerts associated with the transaction to the merchant, consumer, issuer, and/or acquirer through the transaction gateway interface 601.

### Enrollment

The consumer 102 may use a client computer 104 to visit the merchant website 108(a) and wish to conduct a purchase transaction via the merchant website 108(a). To conduct the purchase transaction, the consumer 102 may have the option to enroll a device, such as a mobile device, by providing a device identifier in a payment information online request form on the merchant website 108(a). Enrolling the device allows the consumer 102 to make future online transactions via the merchant website 108(a) more efficiently since the device and other payment information may already be approved during enrollment to verify the identity of the consumer 102.

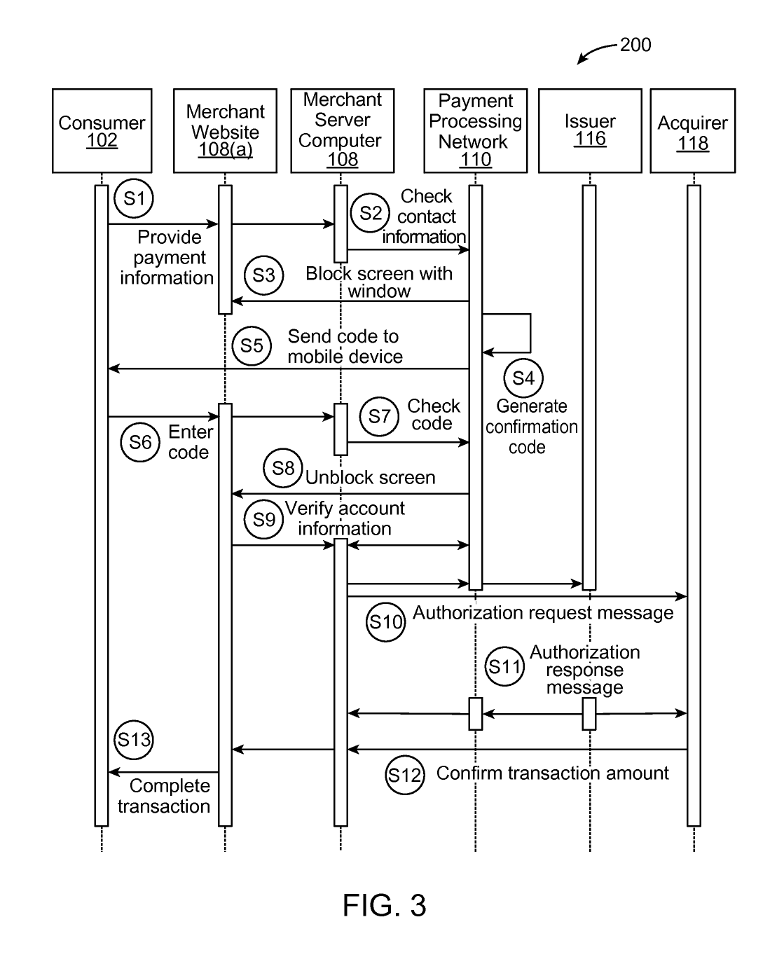

FIG. 3 shows a flowchart 200 of a method according to an embodiment of the invention.

In step S1, the consumer 102 provides payment information, including account information (e.g., PAN, CVV2) and contact information (e.g., mobile device identifier) to the merchant website 108(a) hosted on the merchant server computer 108. In embodiments of the invention, the merchant website 108(a) may display a payment information request form for the consumer to input the requested payment information. The consumer 102 may access the merchant website 108(a) on a client computer, mobile device, or any other device capable of connecting to the Internet and displaying the payment information request form.

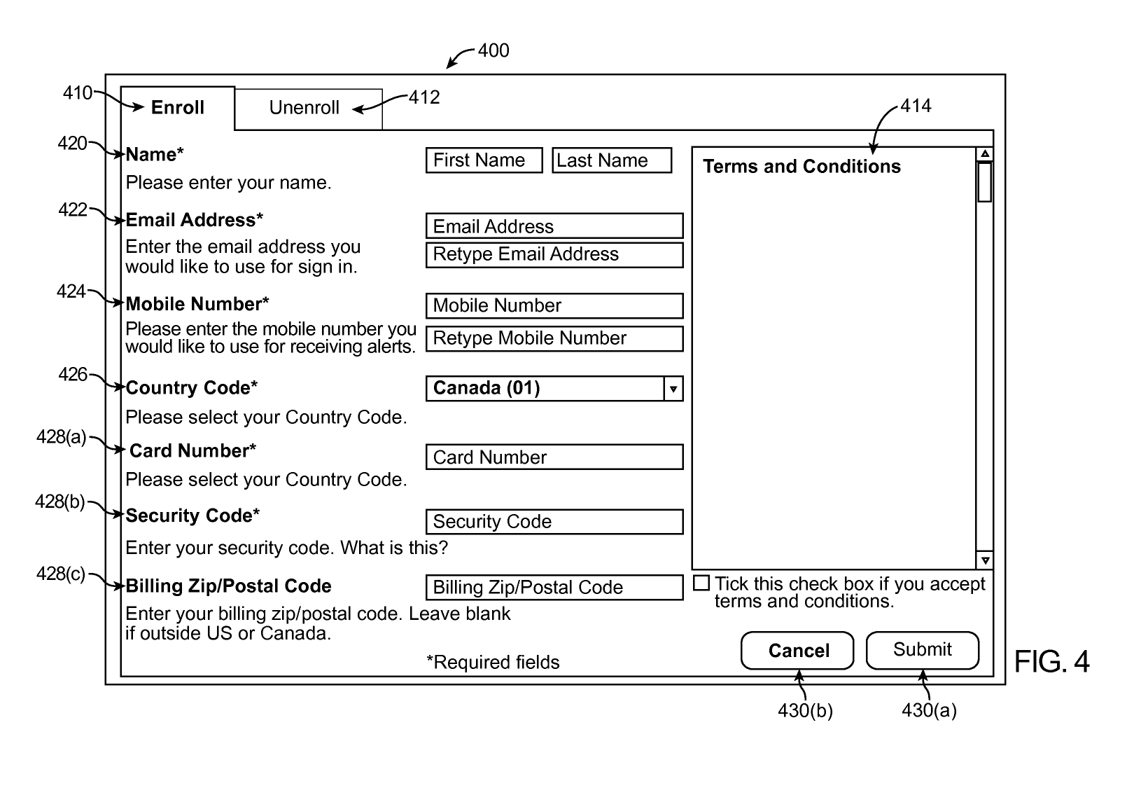

Illustratively, FIG. 4 depicts an exemplary merchant's page displayed on the client computer according to an embodiment of the invention. This page contains a payment information request form 400 containing input regions to collect data for enrollment. In some embodiments of the invention, the information request form on the merchant's page can have the option to select different request forms or tabs to enroll 410 or to unenroll 412. To enroll, the information request form 400 may request consumer data to be entered into input regions. Exemplary data can be consumer information, such as name of the consumer to be billed 420, email address 422, mobile device number 424, and country code. The information request form 400 may also request account information, such as payment card number (i.e., PAN) 428(a), security code (e.g., CVV2) 428(b), and billing ZIP 428(c). The information request page 400 can also have a region displaying terms and conditions 414, or other notifications to the consumer. The consumer can use a “Submit” navigation button 430(a) to submit the data entered into the information request form 400, or use a “Cancel” navigation button 430(b) to cancel the transaction and delete all data.

The client computer 104 can receive payment information, including account information and contact information, entered by the consumer 102 through the payment information request form provided by the merchant website 108(a). The client computer 104 may communicate with the merchant server 108 via the Internet 106 to display the merchant website 108(a), and to receive and submit data.

In step S2, the merchant server computer 108 may transmit and check the contact information of the consumer with the payment processing network 110. The contact information may include a device identifier or email address associated with the consumer. The contact information provided may be used to check if the device identifier has already been enrolled and associated with another account. The payment processing network 110 may store enrolled device identifiers and their associated accounts in a device identifier database and an accounts database.

In step S3, the payment information request form displayed to the consumer 102 on the client computer via the merchant website 108(a) is blocked by the payment processing network 110. In embodiments of the invention, the payment information request form may be blacked out or blocked by a pop-up window or other means to prevent the consumer 102 from further inputting or altering the payment information entered on the form, and may be implemented by the payment processing network 110 through the merchant server computer 108 and displayed on the consumer's client computer. The payment processing network 110 may communicate with the merchant server computer 108 through a secure protocol, such as secure sockets layer (SSL), to identify the client computer 104 of the consumer 102 so that only the payment information request form displayed on the client computer 104 of the consumer 102 is blocked or frozen. Then the confirmation code request window may appear with an input region for the consumer 102 requesting a confirmation code.

The blocking of the payment information request form, the appearance of the confirmation code request window, or other means of restricting access to the payment information request form or requesting the confirmation code may be implemented by Internet-enabled program code in a software language (e.g., Javascript) provided by the payment processing network 110. In one embodiment, the blocking of the payment information request form may be implemented using a modal window in a Graphical User Interface system. A modal window is a child window to a parent application that requires users to interact with it before they can return to operating the parent application, thus preventing the workflow on the parent application main window. In yet another exemplary implementation of the embodiment, the blocking of the payment information request form may be implemented by displaying a blocking page above the payment information request form page that entirely covers the payment information request form page. The blocking page may be implemented with a depth (Z-depth) greater than the depth of the payment request form page. Furthermore, the blocking page may be implemented with the confirmation code request window centrally positioned inside the blocking page. The entire blocking page may be implemented to be partially transparent, except for the confirmation code request window, thus giving the illusion of a pop-up window with the rest of the page blacked out. This implementation restricts the consumers' 102 access only to the blocking page containing the confirmation code request window. Once the confirmation code is verified by the payment processing network 110, the blocking page is removed and the consumer 102 again gains access to payment information request form page.

While the payment information request form is being blocked, in step S4, the payment processing network 110 generates the confirmation code. The confirmation code may be a sequence of letters or numbers, or a combination of both. For example, suitable confirmation codes may be 485928, A78F, or fcyztx. The confirmation code may be randomly generated or generated using an algorithm.

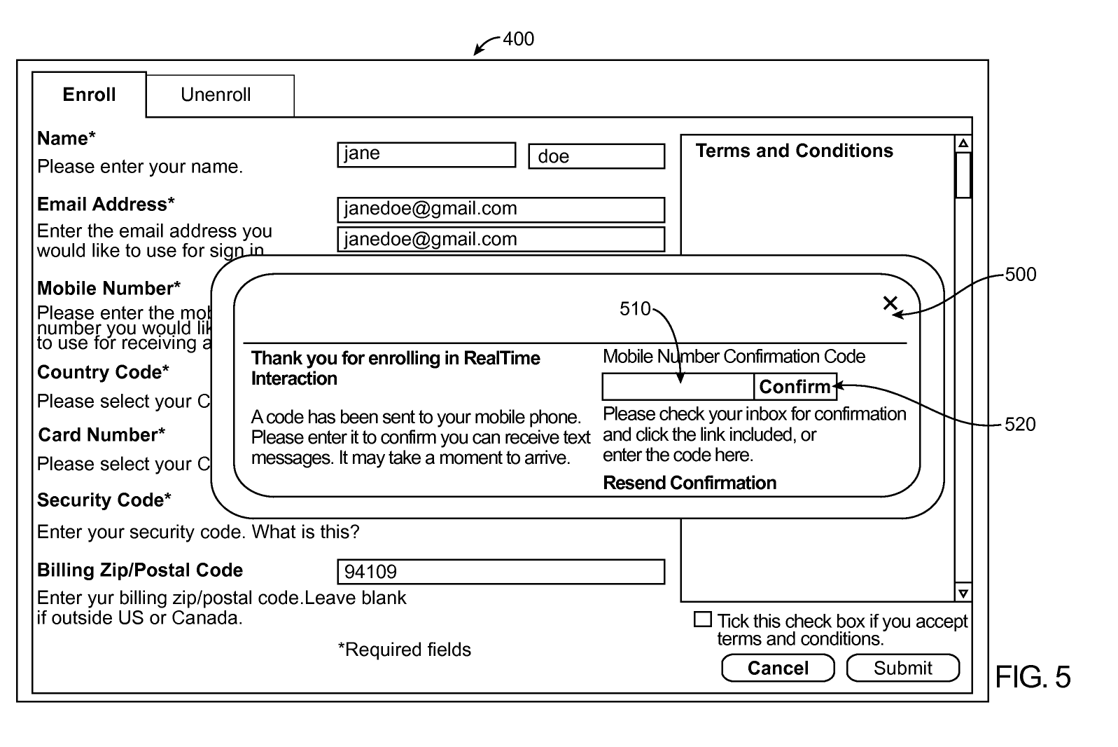

Illustratively, once the consumer has entered in the payment information, including the device identifier, and clicks “Submit” 430(a), the payment information request form 400 (in FIGS. 4 and 5) is blocked or frozen with an overlay or other method to prevent further tampering or editing, as shown in FIG. 5. In the exemplary blocked screenshot shown in FIG. 5, the payment information request form 400 is blocked with a pop-up confirmation code request window 500, containing an input region 510 for a confirmation code sent to the device number by the payment processing network. In the meantime, the payment processing network 110 or other entity can retrieve the device identifier 424 from the payment information provided by the payment information request form 400.

In step S5, the confirmation code generated by the payment processing network 110 is sent to the device identifier of the consumer 102. The confirmation code may be sent via email, SMS, MMS, or text message over a telecommunications network or other network interface. In other embodiments of the invention, the confirmation code may be sent to an email address provided by the consumer 102 in the payment information request form on the merchant website 108(a).

In step S6, the consumer 102 enters the confirmation code received on the device into the confirmation code window blocking the payment information request form of the merchant website 108(a) hosted on the merchant server computer 108. The consumer may manually type in the confirmation code into the input region of the confirmation code request window, or in other embodiments, the confirmation code may be transmitted from the device to the client computer via RFID, Bluetooth, or other wireless means.

In step S7, the merchant server computer 108 communicates with the payment processing network through a secure protocol (e.g., SSL) to forward the entered confirmation code to the payment processing network 110. The payment processing network 110 checks the confirmation code entered to verify that is the same code generated and sent to the device identifier. Once it has been determined that the confirmation code entered into the confirmation code request window matches the confirmation code generated, the payment processing network 110 may then enroll the device identifier by storing it in the device identifier database, and associate the device identifier with an account in the account database. Thus, in future transactions with the device, the payment processing network 110 may immediately identify and link the enrolled device identifier with its associated account.

When the confirmation code has been verified, in step S8, the payment processing network 110 then unblocks the payment information request form of the merchant website 108(a). Unblocking the payment information request form may include removing the confirmation code window and allowing the consumer 102 to regain access to edit the payment information request form of the merchant website 108(a) hosted on the merchant server computer 108. This may be implemented by the payment processing network 110 using secure protocols to communicate with the merchant server 108 and the client computer 104 so that only the payment information request window displayed on the specific client computer 104 of the consumer 102 is unblocked and the consumer 102 may continue. In some embodiments of the invention, the consumer 102 may be asked to provide additional payment information, such as account information (e.g., PAN, CVV2, billing address) or edit payment information previously entered.

Illustratively, the payment processing network checks the device identifier for its status. In certain implementations, the status can include the number of accounts (PANs) associated with the device identifier, the number of bad/failed attempts using the device identifier, etc. If the status is approved such that the device is not locked and does not have too many PANs enrolled to it, the payment processing network can generate a confirmation code which will be sent to the device. In certain implementations, a confirmation code can be randomly generated and sent to the consumer's mobile phone via SMS. In other implementations, the confirmation code may be sent by other contact information of the consumer, such as by email, voicemail, instant message, etc.

FIG. 5 shows an embodiment of the invention when the payment information request form 400 displaying on the client computer is blocked, and the confirmation code request window 510 appears, requesting the confirmation code sent to the associated device. In some cases, it may take a few moments for the SMS to arrive to the consumer's mobile device. Additionally, the consumer can have a mobile device that is capable of receiving text messages and is in service, which is not cost effective for persons making unauthorized purchases through malicious probing. At this stage, the account information (e.g., payment card information) may not have been validated in certain implementations. In some embodiments, the account information may be validated only as to format.

If the consumer has entered the correct confirmation code into the blocking confirmation code request window's 500 input region 510 (i.e., the consumer enters the code sent to them on their device), it can be confirmed that the consumer has possession of the device, and the payment processing network can initiate verification of the transaction using the account information. If the confirmation code entered is valid (meaning the consumer has possession of the device), the payment information, including account information, can be validated. If successful, the authorized consumer can be express enrolled. The total cards enrolled for that device can be increased by 1 within the records of the payment processing network 110. The payment card number can be enrolled to the device, and recorded. The payment information, such as the account information (e.g., payment card number), can then be authenticated.

If the confirmation code entered is successful, but some or all of the account information is incorrect, a failed attempt is tallied against the device identifier. In certain embodiments, all card information is flagged as incorrect with a generic message to fix payment information, such as “please fix payment information.” The consumer may not be informed of which piece of data is incorrect, to further deter malicious probing and guessing.

The consumer can correct the payment information with a limited number of attempts (e.g., three attempts), which can all be recorded against the device identifier. If the payment information is validated (by AVS or other suitable systems) within the maximum number of failed attempts allowed for the device, the payment card is enrolled. If the consumer is unable to correctly enter the payment information in the number of allowable attempts, the card is not enrolled, and the device identifier is blocked from enrolling any more payment cards.

In step S9, the payment information entered into the payment information request form of the merchant website 108(a) may be sent from the merchant server computer 108 to the payment processing network 110 to initiate verification of the account information.

### Transaction

In addition to conducting an enrollment of the device, the consumer 102 may wish to conduct a transaction to purchase products via the merchant website 108(a). To complete a purchase transaction after successful enrollment of the device, in step S10, the merchant server computer 108 may generate an authorization request message to the payment processing network 110. The payment processing network may then forward the authorization request message to the issuer 116. In some embodiments of the invention, the acquirer 118 may also receive the authorization request message from the merchant server computer 108. The authorization request message may include an issuer account identifier. The issuer account identifier may be a payment card account identifier associated with a portable consumer device (e.g., payment card) and the issuer 116. The authorization request message may request that the issuer 116 of the portable consumer device authorize the transaction. An authorization request message according to an embodiment of the invention may comply with ISO 8583, which is a standard for systems that exchange electronic transactions made by cardholders using portable consumer devices (e.g., payment cards).

After the issuer 116 has processed the authorization request message, in step S11, the issuer 116 generates an authorization response message, which is transmitted to the acquirer 118 and payment processing network 110, and further forwarded to the merchant server computer 108. The authorization response message indicates whether the issuer 116 has authorized the transaction or not.

If the issuer 116 has authorized the transaction, in step S12, the acquirer 118 confirms and secures the transaction amount in the authorization response message to the merchant server computer 108. The confirmation of the transaction may be displayed on the merchant website 108(a) hosted on the merchant server computer 108.

In step S13, the merchant website 108(a) may indicate to the consumer 102 confirming that the transaction has been authorized and completed.

Embodiments disclosed herein have a number of advantages. Because a payment information request form is blocked in embodiments of the invention, unauthorized consumers cannot endlessly try combinations of numbers in a cost effective manner. However, an authorized consumer may still have a limited number of attempts to edit the account information in the payment information request form for human error without significant delay to the transaction process.

Another advantage of embodiments of the invention is that the account information is only authorized when a valid confirmation code has been entered by the consumer in possession of the device. This provides additional security in online transactions for the consumer and the merchant in authorizing the transaction. Both the consumer and merchant are protected from potentially fraudulent transactions.

Additionally, according to embodiments of the invention, an authorization request message is generated by the merchant and sent to the payment processing network and issuer only after the identity of the consumer has been confirmed and validated. Thus the number of unnecessary authorization request messages generated by the merchant for potentially fraudulent transactions (and more likely to be declined) is reduced. Reducing the number of unnecessary authorization request and response messages transmitted back and forth for potentially fraudulent transactions improves the efficacy, accuracy, and efficiency of the transaction processing.

Embodiments of the invention can be used a long as a device is specifically tied to a consumer.

Embodiments of the invention can include laptop computers and stationary computers.

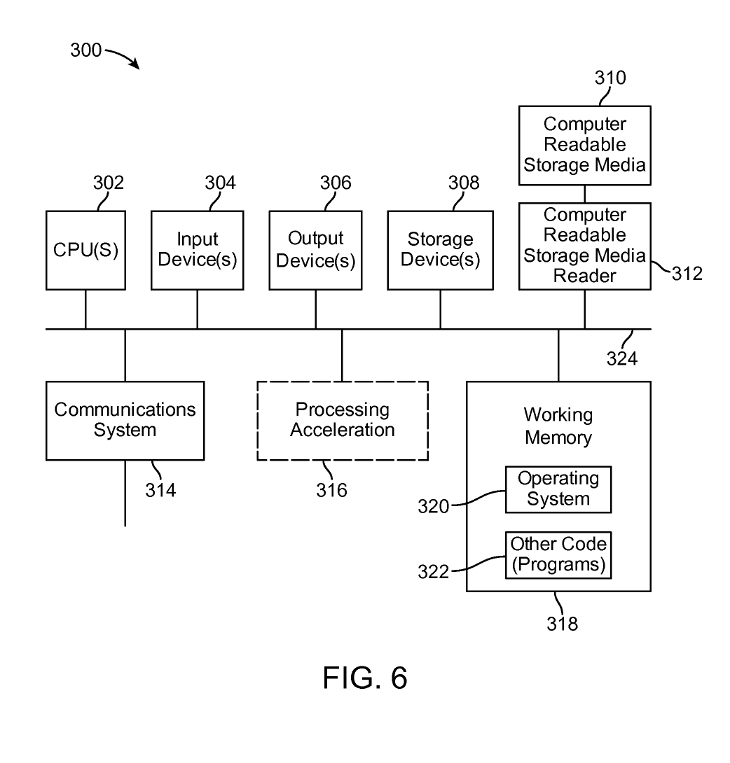

FIG. 6 illustrates an exemplary computer system 300, in which various embodiments may be implemented. The system 300 may be used to implement any of the computer systems described above (e.g., client computer, a server computer at the payment processing network, a computer apparatus at the merchant, etc.). The computer system 300 is shown comprising hardware elements that may be electrically coupled via a bus 324. The hardware elements may include one or more central processing units (CPUs) 302, one or more input devices 304 (e.g., a mouse, a keyboard, etc.), and one or more output devices 306 (e.g., a display device, a printer, etc.). The computer system 300 may also include one or more storage devices 308. By way of example, the storage device(s) 308 can include devices such as disk drives, optical storage devices, solid-state storage device such as a random access memory (“RAM”) and/or a read-only memory (“ROM”), which can be programmable, flash-updateable and/or the like.

The computer system 300 may additionally include a computer-readable storage media reader 312, a communications system 314 (e.g., a modem, a network card (wireless or wired), an infra-red communication device, etc.), and working memory 318, which may include RAM and ROM devices as described above. In some embodiments, the computer system 300 may also include a processing acceleration unit 316, which can include a digital signal processor DSP, a special-purpose processor, and/or the like.

The computer-readable storage media reader 312 can further be connected to a computer-readable storage medium 310, together (and, optionally, in combination with storage device(s) 308) comprehensively representing remote, local, fixed, and/or removable storage devices plus storage media for temporarily and/or more permanently containing, storing, transmitting, and retrieving computer-readable information. The communications system 314 may permit data to be exchanged with the network and/or any other computer described above with respect to the system 300.

The computer system 300 may also comprise software elements, shown as being currently located within a working memory 318, including an operating system 320 and/or other code 322, such as an application program (which may be a client application, Web browser, mid-tier application, RDBMS, etc.). It should be appreciated that alternate embodiments of a computer system 300 may have numerous variations from that described above. For example, customized hardware might also be used and/or particular elements might be implemented in hardware, software (including portable software, such as applets), or both. Further, connection to other computing devices such as network input/output devices may be employed.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A server computer apparatus comprising:
a processor; and
a computer-readable storage medium, comprising code executable by the processor for implementing a method comprising,
providing an online request form to a consumer,
receiving payment information including a device identifier from the online request form during an online transaction,
restricting access to the online request form,
providing an input region,
generating a confirmation code,
transmitting the confirmation code to the device identifier,
receiving the confirmation code via the input region, and
allowing access to the online request form if the confirmation code entered via the input region matches the generated confirmation code.

2. The server computer apparatus of claim 1 wherein the confirmation code comprises letters, numbers, or combinations thereof, and wherein the device identifier is a mobile device identifier.

3. The server computer apparatus of claim 1, wherein the input region is a window requesting the confirmation code.

4. The server computer apparatus of claim 1, wherein the method further comprises:
initiating the verification of the payment information only when the confirmation code entered into the input region is accepted and matches the generated confirmation code; and
notifying the consumer that the online transaction is complete.

5. The server computer apparatus of claim 3, wherein the method further comprises enrolling the approved device and the verified payment information of the consumer.

6. A method comprising:
providing an online request form to a consumer;
receiving payment information including a device identifier from the online request form during an online transaction;
restricting access to the online request form;
providing an input region;
generating a confirmation code;
transmitting the confirmation code to the device identifier;
receiving the confirmation code via the input region; and
allowing access to the online request form if the confirmation code entered via the input region matches the generated confirmation code.

7. The method of claim 6 wherein the confirmation code comprises letters, numbers, or combinations thereof, and wherein the device identifier is a mobile device identifier.

8. The method of claim 6 wherein the input region is a window requesting the confirmation code.

9. The method of claim 6 further comprising:
initiating the verification of the payment information only when the confirmation code entered via the input region is accepted and matches the generated confirmation code;
approving the device identifier; and
notifying the consumer that the online transaction is complete.

10. The method of claim 9 further comprising enrolling the approved device identifier and the verified payment information of the consumer.

11. The method of claim 6, wherein the online request form is provided to the consumer through a merchant website, and wherein the online transaction is a payment transaction.

12. A client computer apparatus comprising:
a processor; and
a computer-readable storage medium, comprising code executable by the processor for implementing a method comprising:
displaying an online request form to a consumer during an online transaction;
receiving payment information, including a device identifier in the online request form, wherein the online request form is thereafter blocked;
displaying an input region;
receiving entry of a confirmation code in the input region, the confirmation code received by the device; and
allowing the consumer to access the online request form.

13. The client computer apparatus of claim 12 wherein the confirmation code comprises letters, numbers, or combinations thereof, and wherein the device identifier is a mobile device identifier.

14. The client computer apparatus of claim 12 wherein the input region is a window requesting the confirmation code.

15. The client computer apparatus of claim 12, wherein the method further comprises:
initiating verification of the payment information only when the confirmation code entered via the input region is accepted and matches the generated confirmation code;
approving the device identifier; and
receiving confirmation that the online transaction is complete.

16. The client computer apparatus of claim 15, wherein the method further comprises enrolling the approved device identifier and the verified payment information of the consumer.

17. A method comprising:
displaying an online request form to a consumer during an online transaction;
receiving payment information, including a device identifier in the online request form, wherein the online request form is thereafter blocked;
displaying an input region;
receiving entry of a confirmation code in the input region, the confirmation code received by the device; and
allowing the consumer to access the online request form.

18. The method of claim 17 wherein the confirmation code comprises letters, numbers, or combinations thereof, and wherein the device identifier is a mobile device identifier.

19. The method of claim 17 wherein the input region is a window requesting the confirmation code.

20. The method of claim 17, wherein the method further comprises:
initiating verification of the payment information only when the confirmation code entered via the input region is accepted and matches the generated confirmation code;
approving the device identifier; and
receiving confirmation that the online transaction is complete.

21. The method of claim 20, wherein the method further comprises enrolling the approved device identifier and the verified payment information of the consumer.

22. The method of claim 17, wherein the online request form is provided to the consumer through a merchant website, and wherein the online transaction is a payment transaction.
